(19) United States
(12) Patent Application Publication
(10) Pub. No.: US 2010/0143199 A1
(43) Pub. Date: Jun. 10, 2010

(54) PIPETTE TIP PACKAGE

(75) Inventor: Arto LAHTI, Tuusula (FI)

Correspondence Address: NIXON & VANDERHYE, PC, 901 NORTH GLEBE ROAD, 11TH FLOOR, ARLINGTON, VA, 22203, US

(73) Assignee: THERMO FISHER SCIENTIFIC OY, VANTAA (FI)

(21) Appl. No.: 12/574,845

(22) Filed: Oct. 7, 2009

(30) Foreign Application Priority Data
Oct. 20, 2008 (FI) 20085988

(51) Int. Cl. B65D 73/00; B01L 9/00

(52) U.S. Cl. 422/104; 206/486

(57) ABSTRACT

The invention relates to a pipette by package, which has a plurality pipette tips in separate enclosures. The enclosures are securely closed by a joint lid.

### TECHNICAL FIELD

The invention relates to pipettes for use in liquid dispensing and concerns tip cones or tips used therein. Tips according to the invention are suitable for use, for example, when utmost cleanness is required.

### BACKGROUND ART

Pipettes are provided with disposable tip cones or tips, which are fixed to the end of a pipette's suction channel and into which the liquid to be pipetted is drawn. The pursuit of utmost cleanness is often a reason to use individually packed tips.

A traditional solution for individual packages has been a vacuum-molded channel type bag, in which the tip lies on its side. The bag has a heat-sealed cover. The bags are packed in bulk containers, which are then sterilized by irradiation. The user opens the bag at the tip attachment end and holds the tip through the bag while fixing the tip to a pipette.

There are also trays available for tips. In this case, the tip has a widened top end and the tray has holes for suspending the tips thereby. Picking up tips from a tray is easy, especially for a multichannel pipette. In the manufacture of sterile tray packages, the entire tray, along with its tips, is placed inside a bag which is then sterilized by irradiation.

WO 97/39827 describes a device comprising a plurality of vessel-like casings each containing one tip. The casings are closed hermetically but can be opened at the top.

### GENERAL DESCRIPTION OF THE INVENTION

What has been invented now, is a pipette tip package, a combination of a pipette tip package and a tray, and a method of manufacturing a pipette tip package.

According to the invention, the pipette tip is placed in an enclosure with a closed bottom end and an open top end, such that the tip has its top end towards the top end of the enclosure. Then, the top ends of a plurality of separate enclosures are securely closed by fixing a joint lid thereto to form a multi-tip package. Such a unit can then be cut for individual packages. The lid can be fixed for example by heat sealing, gluing or by a friction joint. After the closing operation, the package can still be sterilized, particularly by irradiation.

The user opens the lid and inserts the end of a pipette's suction channel into the tip. The procedure is easy and, while being fixed in place, the tip is exposed as little as possible to contamination.

Tips are manufactured virtually always from a suitable plastic by injection molding. The enclosure is also most conveniently manufactured by injection molding. Production is feasible with automated production lines currently in service. Cleanness in production is easily ensured in the manufacture of tips according to the invention. The invention enables also loading a tray in such a way that sterility is easily maintained.

The tip may have an enlargement in its upper part, constituting a shoulder with the tip's outer surface. The enlargement may consist of longitudinal ribs present in the upper part of the tip. The enclosure may have an internal reduction, specifically a shoulder, which responds to that of the tip. Hence, in the process of fixing it to a pipette, the tip can be pressed against the internal reduction of the enclosure for a good sealing effect. For this purpose, the enclosure must naturally be sufficiently rigid for pressing the tip against it with an adequate force.

The enclosure may also have in its upper part an enlargement on its outer surface. This enables loading the enclosure on a tray, which has an aperture for placing the enclosure therein to be suspended by the enlargement.

Nevertheless, the lid of a multi-tip package can be opened, as necessary, even without cutting the lid. In this case, the unit can be placed on a tray with an aperture for each enclosure, The enclosures are arranged in a multi-tip package most conveniently in straight rows. Hence, the lid can be formed always between the rows with a cut, such as a perforation. This enables an easy opening of the lid, one row at a time. From the tray, tips are handy to pick up from a row for a multichannel pipette of a matching pitch.

The invention is of a particular benefit, specifically in the case of tray packages. The fabrication of sterile packages is easier than at present. The only components that have to be superclean are the tip, the interior of the enclosure, and the internal side of the lid. The enclosures can be manufactured in the immediate vicinity of tip production and possibly even concurrently with tips. After the enclosures are closed, the tips are protected from contaminations. There is no need of further protecting the product by a plastic bag, nor do the tips require a traditional perforated plate for shipping. Savings in material and labor are remarkable.

Less packaging material is needed and the size of shipped packages is smaller as the user need not be always supplied with a new tray along with the tips. There is no need to expose more tips from the tray than those required at a time, whereby the tips left in the tray remain absolutely clean.

According to the invention, it is easier than before to achieve the highly stringent requirements of certain applications, regarding the absence of nuclease and endotoxin.

### DRAWINGS

The accompanying drawings constitute a part of the written description of the invention and relate to the detailed description of some embodiments of the invention presented hereinafter. In the drawings,

FIG. 1 shows an individual tip package in a cross-sectional view,

FIG. 2 shows a multi-tip package and

FIG. 3 an individual tip package cut therefrom by stamping,

FIG. 4 shows a sliced multi-tip package and

FIG. 5 an individual tip package cut therefrom, and

FIG. 6 shows the multi-tip package of FIG. 4 in a tray.

### DETAILED DESCRIPTION OF SOME EMBODIMENTS OF THE INVENTION

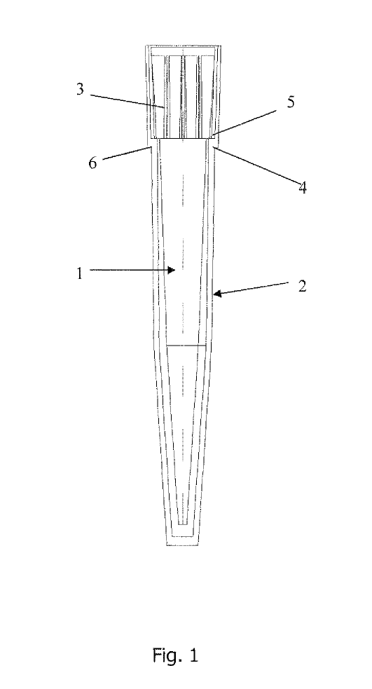

The tip package of FIG. 1 includes a pipette tip 1, placed in a rigid tube 2 which has a closed bottom such that the tip has its bottom end towards the tube's bottom. The tip has its upper part provided with protruding longitudinal ribs 3 whose bottom ends make up a shoulder 4. The tube has a configuration which matches that of the tip but is larger to such an extent that the tip fits inside the tube. The tube has an internal shoulder 5 which responds to that of the tip, thereby preventing the tip's bottom end from touching the tube's bottom. Slightly below the internal shoulder, the tube has its outer surface provided respectively with an external shoulder 6. The tip is placed in the tube from open top end, which is then closed securely with a lid. The closed package can be sterilized, most preferably by irradiation.

The tip user removes the lid, inserts the end of a pipette's suction channel into the package, whereby the tip has its shoulder 4 pressing against the tube's shoulder 6 and the tip is set firmly in position at the end of the pipette.

Both the tip 1 and the tube 2 are fabricated by injection molding. The tip is placed in the tube, and the thus obtained package is closed immediately, most preferably by heat sealing.

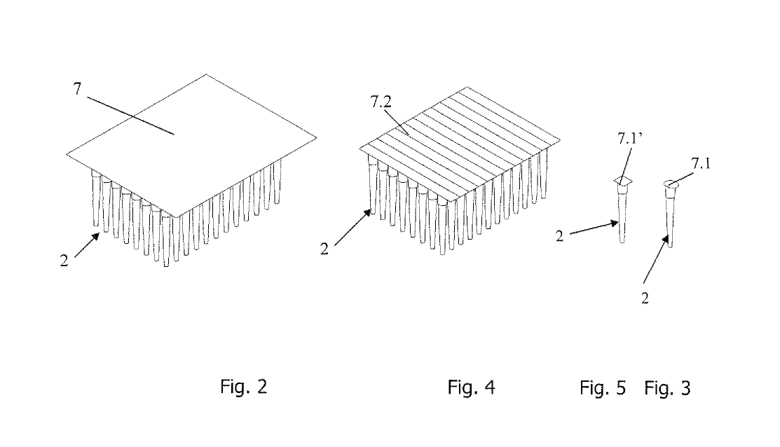

As shown in FIG. 2, several tip packages are closed with a joint lid membrane 7 for a single web of tip packages. This can be cut by stamping for the individual packages of FIG. 3, which are closed by a lid 7.1. This can be done during a manufacturing process, and the individual packages can be packed in bulk containers. However, the web of tip packages can also be delivered as a whole to the user, whereby the user can personally cut the web for smaller units or remove the lid always to an extent enough for picking up the number of tips needed at each time. The web of tips can also be placed in a tip tray, which includes apertures for having the tips suspended thereby.

According to FIG. 2, the tip packages are in the configuration of a rectangular matrix, corresponding for example to the pitch of a 96-well microtitration plate. According to FIG. 4, the lid membrane is perforated between the vertical rows for rectilinear strips 7.2. The user is able to cut a slice for individual packages of FIG. 5, which are provided with a lid 7.1′.

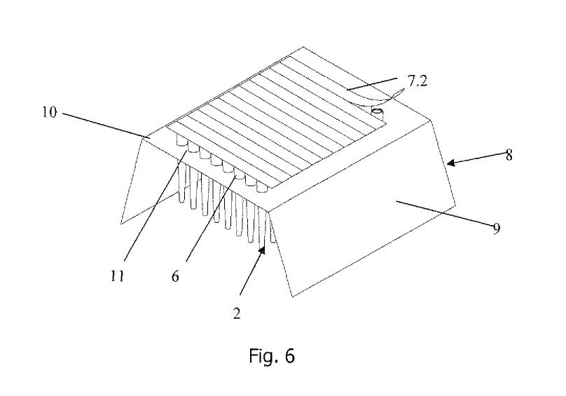

FIG. 6 shows the tip package unit of FIG. 4 loaded in a tray 8. The tray has legs 9 and a lid 10 connecting the same. The lid 10 is provided with apertures 11, in which the tip packages hang suspended from the external shoulder 6 of the tube 2. The strip 7.2 can be removed all at once, thus obtaining by a single action the tips for an 8-channel pipette. If desired, the slice can also be removed little by little for picking up fewer tips at a time.

If desired, the tube 2 below the external shoulder 6 can be further provided with an annular groove for snap-fitting the lid 10 therein, thus providing a robust structure.

1. A pipette tip package, comprising
a plurality of separate enclosures, each having a closed bottom end and an open top end,
in each enclosure, a pipette tip having an upper end which can be attached to a pipette, whereby the tip is placed inside the enclosure with the upper end towards the top end of the enclosure, and
a joint lid securely attached to the top ends of the enclosures and connecting the enclosures together.

2. The package of claim 1, wherein the lid is attached to the top ends of the enclosures by heat sealing.

3. The package of claim 1, wherein the lid is in the form of at least one rectilinear strip for joining multiple packages.

4. The package of claim 1, wherein the joint lid connects the enclosures in the form of a rectangular matrix comprising at least two linear rows of multiple tip packages.

5. The package of claim 4, wherein the lid is perforated between the rows of enclosures enabling a single row of enclosures to be opened.

6. The package of claim 1, wherein the pipette tips are sterilized.

7. A combination of a pipette tip package and a tray comprising:
a. an enclosure having a closed bottom end and an open top end;
b. a pipette tip having an upper end which can be attached to a pipette, wherein the tip is placed inside the enclosure with the upper end towards the top end of the enclosure;
c. a joint lid securely attached to the top ends of at least two enclosures;
d. a tray having an upper surface with multiple apertures for receiving enclosures and a downwardly extending leg for maintaining the upper surface of the tray at a height at least sufficient to accommodate the enclosures.

8. The combination of claim 1, wherein the lid is in the form of at least one rectilinear strip for joining multiple packages.

9. The combination of claim 7 wherein the lid connects the packages in the form of a rectangular matrix comprising at least two linear rows of multiple packages.

10. The combination of claim 9 wherein the lid is perforated between the rows of packages enabling a single row of packages to be opened.

11. A method of manufacturing a pipette tip package, wherein
one pipette tip having an upper end which can be attached to a pipette is placed in an enclosure which has a closed bottom end and an open top end, such that the pipette tip has its upper end towards the top end of the enclosure, and
a plurality of the enclosures are closed securely by attaching a lid thereto.
